(19) United States
(12) Patent Application Publication
(10) Pub. No.: US 2018/0318858 A1
(43) Pub. Date: Nov. 8, 2018

(54) SYSTEM AND METHOD FOR DISPENSING LIQUID FOAM, IN PARTICULAR A DIRECT-FOAM CLEANING PRODUCT

(71) Applicant: Dispensing Technologies B.V., DE HELMOND (NL)

(72) Inventors: Wilhelmus Johannes Joseph MAAS, KV SOMEREN (NL); PAULO NERVO, AE HOOGELOON (NL)

(73) Assignee: Dispensing Technologies B.V., DE HELMOND (NL)

(21) Appl. No.: 15/772,141

(22) PCT Filed: Oct. 31, 2016
(86) PCT No.: PCT/NL2016/050756

§ 371 Date: Apr. 30, 2018

(30) Foreign Application Priority Data
Oct. 30, 2015 (NL) 2015694

(51) Int. Cl. B05B 7/00

(52) U.S. Cl. CPC B05B 7/0018

(57) ABSTRACT

A system for dispensing liquid foam, in particular a direct foam cleaning product, comprises a container for the liquid and a dispensing apparatus connected to the container. The dispensing apparatus comprises a pump comprising a pump chamber in fluid communication with the container and a piston arranged in the pump chamber, the piston and pump chamber being movable with respect to one another. An outlet channel connects the pump chamber to a nozzle. A pre-compression valve is arranged between the outlet channel and the nozzle; and a buffer comprising a buffer chamber is connected to the outlet channel. The buffer chamber includes a compressible variator arranged therein for varying the usable volume of the buffer chamber; wherein the nozzle, the buffer and the pump are configured and dimensioned such that the foam is dispensed in a predetermined spray pattern.

### FIELD OF THE INVENTION

The present invention relates to dispensing of liquid foam, in particular a direct-foam cleaning product. More specifically, the present invention relates to a system for dispensing liquid foam including a container, a pump and a buffer.

### BACKGROUND OF THE INVENTION

Hand dishwashing is typically performed by applying dishwashing detergent to a sponge or cleaning implement and scrubbing dishware with the implement; or adding the detergent to a water bath in a sink and soaking/scrubbing the dishware in the detergent water bath. Such conventional methods may take the consumer longer periods of time than necessary to clean dishware when it is not heavily soiled or when there are only a few items to clean (e.g. knife, spatulas, soup ladles, etc. used briefly to prepare food). Such conventional methods may also result in wasted dishwashing detergent product (i.e. dosed amount may be more than needed to clean the dishware).

Finding efficient ways of cleaning dishware may be desired by many consumers. One approach to quicker cleaning is direct application of dishwashing detergent onto the soiled dishware followed by an optional light scrub and then a water rinse. One attempt in the art of direct-foam cleaning is “Method Power Foam Dish Soap” dishwashing detergent sold by Method Products (San Francisco, Calif., U.S.A.). The Method product provides a dishwashing composition in a conventional spray bottle. Dispensing direct-foam dishwashing products from conventional spray bottles, however, may not effectively clean dishware and may not provide good surface area foam coverage and/or lasting foam coverage for efficient cleaning. To compensate for the lack of coverage and non-lasting coverage, multiple spray actions are needed which can negatively affect user experience, lead to overconsumption of the cleaning product, and may also increase product bounce back from surfaces when spraying. Such bounce back can cause wasted product and possible product inhalation risks.

As such, it is desirable to improve cleaning efficiency by providing a dispensing system that will ensure good coverage on surfaces per dose of the direct-foam cleaning product with minimal bounce back and without compromising tough food cleaning.

### SUMMARY OF THE INVENTION

To this end the invention provides a system for dispensing liquid foam, in particular a direct foam cleaning product, comprising a container for the liquid and a dispensing apparatus connected to the container. In accordance with the invention the dispensing apparatus comprises a pump comprising a pump chamber in fluid communication with the container and a piston arranged in the pump chamber, the piston and pump chamber being movable with respect to one another; an outlet channel connecting the pump chamber to a nozzle; a pre-compression valve arranged between the outlet channel and the nozzle; and a buffer comprising a buffer chamber connected to the outlet channel, the buffer chamber including a compressible variator arranged therein for varying the usable volume of the buffer chamber; wherein the nozzle, the buffer and the pump are configured and dimensioned such that the foam is dispensed in a predetermined spray pattern. By dispensing the foam in a predetermined spray pattern, the effectiveness of the foam is increased.

In one embodiment of the dispensing system the pre-compression valve and the buffer chamber are arranged to define lower and upper limits, respectively, of a dispensing pressure of the foam. In this way the pressure at which the foam is sprayed lies within a relatively narrow bandwidth so as to ensure more uniform foam.

In a further embodiment the pre-compression valve has a cracking pressure of about 2 to 4.5 bar, preferably about 3 to 3.5 bar. At this lower pressure limit the liquid is sprayed in relatively small droplets which will lead to better foaming.

In a further embodiment the buffer chamber and the variator define a maximum value of the dispensing pressure of between 3 and 5.5 bar, preferably about 5 bar. This upper limit for the spraying pressure ensures that the droplets do not become too small, which would lead to inhalation risk.

In some embodiments the pump has a displacement volume that is greater than a maximum throughput of the nozzle. In this way not all liquid from the pump can pass through the nozzle, and part of the liquid will have to be stored for later spraying.

The maximum throughput of the nozzle may be about 1.45 cm³ per second.

The dispensing system may have a buffer chamber having a maximum usable volume that is greater than the displacement volume of the pump. In this way the output of one or more pump strokes may be buffered for later dispensing.

In one embodiment of the dispensing system, the nozzle has a plurality of swirl grooves leading to an inlet funnel, which funnel debouches in a nozzle orifice. The swirl grooves and funnel lead to a final acceleration and energization of the liquid flow just before leaving the nozzle orifice.

The nozzle may have a central bore upstream of the inlet funnel, which is arranged to accommodate a protruding part of the dispenser frame, and wherein the central bore is dimensioned such that a space is formed between and end face of the protruding frame part and a bottom of the bore. In this way part of the liquid is forced through the swirl grooves and part of the liquid is allowed to bypass the swirl grooves and pass through the space between the nozzle and the dispenser frame. This leads to improved flow characteristics of the liquid just before entering the nozzle orifice. For some liquids this leads to improved flow characteristics of the liquid just before entering the nozzle orifice. For other liquids the protruding part of the dispenser frame could be dimensioned to leave no space between the end face of the protruding frame part and the bottom of the bore.

In some embodiments the inlet funnel may be conical and may have a top angle of 20-150°, preferably 50-120°, more preferably about 100°. This angle is selected such as to provide optimum acceleration of the liquid.

In order to ensure an optimum amount of rotation in the liquid, the nozzle may have an odd number of swirl grooves, preferably 3 or 5 swirl grooves.

In one embodiment the nozzle has a divergent expansion area downstream of the nozzle opening. In this expansion area the pressure of the liquid may drop almost instantaneously, thus leading to the formation of the foam.

In some embodiments the expansion area may have aeration openings to allow air into the expanding liquid stream so as to accelerate the foaming process.

The expansion area may be conical and may have a top angle of between 20-120°, preferably between 30-90°, and more preferably about 50°. A conical nozzle is relatively easy to manufacture and may form a surface on which droplets in the expanding liquid stream may break up.

In one embodiment of the dispensing system the variator may comprise a piston that is movable in the buffer chamber and a compression spring engaging the variator piston. Such a spring-loaded piston is mechanically simple and robust.

In an alternative embodiment the variator may comprise a bag filled with a compressible medium. This embodiment lacks movable parts like pistons and springs, which improves long-term reliability of the dispensing system.

In such a dispensing system the buffer chamber may be integrated in the outlet channel. In this way the bag can be acted upon directly by the liquid pressure in the outlet channel and the dispensing system can be more compact.

In a preferred embodiment of the dispensing system the container may be a bag-in-bottle type container. In such a bag-in-bottle container the liquid to be dispensed may be kept completely isolated from the ambient atmosphere during its entire lifetime. Thus the liquid will not be contaminated or age.

In another embodiment the dispensing system further comprises a movable trigger connected to the pump piston or pump chamber for actuating the relevant part and generating liquid pressure. In this way the dispensing system is embodied as a trigger sprayer, which is a structurally simple and cost-effective dispenser.

The invention further relates to a method for dispensing a liquid foam, in particular a direct foam cleaning product. In accordance with the invention, such a method comprises the steps of drawing the liquid from a container and pressurizing the liquid by actuating a pump, wherein the container and the pump form part of a dispensing system; guiding at least a part of the pressurized liquid to a dispensing nozzle of the dispensing system; dispensing the liquid from the nozzle; storing another part of the pressurized liquid in a buffer; and dispensing the stored liquid from the nozzle when the pump is not being actuated; wherein the nozzle, the buffer and the pump are configured and dimensioned such that the foam is dispensed in a predetermined spray pattern.

Preferred embodiments of the dispensing method are defined in dependent claims 21-27.

And finally, the invention relates to a nozzle which is particularly suited for use in a dispensing system of the type defined above.

### BRIEF DESCRIPTION OF THE DRAWINGS

Further features of the invention are set forth in the following detailed description of some exemplary embodiments of the invention and in the drawing figures, in which like elements are identified by reference numerals which are increased by “100”.

FIG. 1 is a scanned image of a direct-foam spray pattern that is achieved using the dispensing system according to the present invention;

FIG. 2 is a cross sectional view of a first embodiment of the dispensing apparatus of the invention;

FIG. 3 shows the liquid flow path through the dispensing system of FIG. 2;

FIG. 4 is an enlarged perspective cross-sectional view of the spray nozzle defined by dashed boundary “4” shown in FIG. 3;

FIG. 5 is a perspective view of the nozzle shown in FIG. 4;

FIG. 6 is a longitudinal sectional view of the nozzle of FIGS. 4 and 5;

FIG. 7 is a rear view of the swirl grooves and inner cone of the nozzle of FIGS. 4-6;

FIG. 8 is a graphical representation of the way the pre-compression valve and buffer of the dispensing apparatus define a narrow bandwidth for the pressure at which the liquid foam is dispensed;

FIG. 9 is a cross sectional view of a second embodiment of the dispensing apparatus of the invention;

FIG. 10 is a cross sectional view of a third embodiment of the dispensing apparatus of the invention; and

FIG. 11 is an enlarged longitudinal sectional view of the nozzle of FIGS. 4-6 as mounted on the dispensing system.

### DETAILED DESCRIPTION OF THE INVENTION

The direct-foam cleaning product of the present invention includes a cleaning composition dispensed from a spray dispenser to form a direct-foam. A “direct-foam” or “direct-product”, as used herein, is a product that forms a foam on the surface to which it is applied, without requiring additional physical, chemical, or like interventions. For example, manual rubbing of a product on a surface to produce foam once the product is dispensed from its container is not a direct-foam product. The direct foam product is applied to the surface directly from the container in which it was stored.

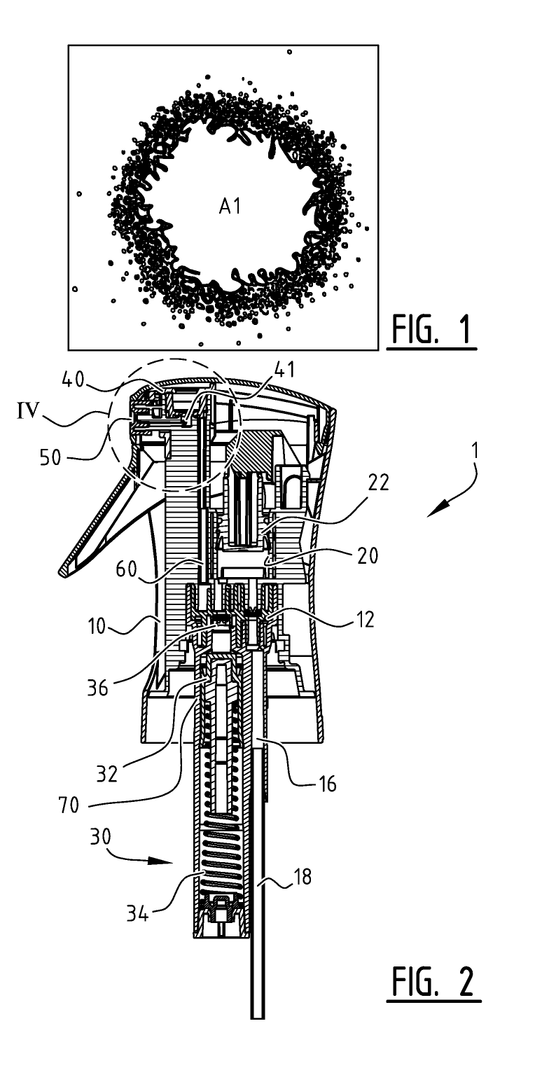

The cleaning composition can be dispensed from a dispensing system in accordance with the invention. As will be described in more detail below, the dispensing system includes a container for the liquid cleaning composition and a dispensing apparatus connected to the container. A suitable container may be a bag-in-bottle type container using the applicant's Flair® technology. The dispensing apparatus includes a pump, a pre-compression valve and a buffer. The pre-compression valve controls the minimum pressure required for liquid to release from the dispensing apparatus and the buffer mechanism controls the maximum pressure of liquid being pumped to and from the buffer chamber. When the composition is dispensed from the dispensing system of the invention, the cleaning composition provides a direct-foam product having a wide ring-like foam pattern as shown in FIG. 1. However, other foam pattern shapes are contemplated and can be achieved through modifications of the nozzle design of the dispensing apparatus.

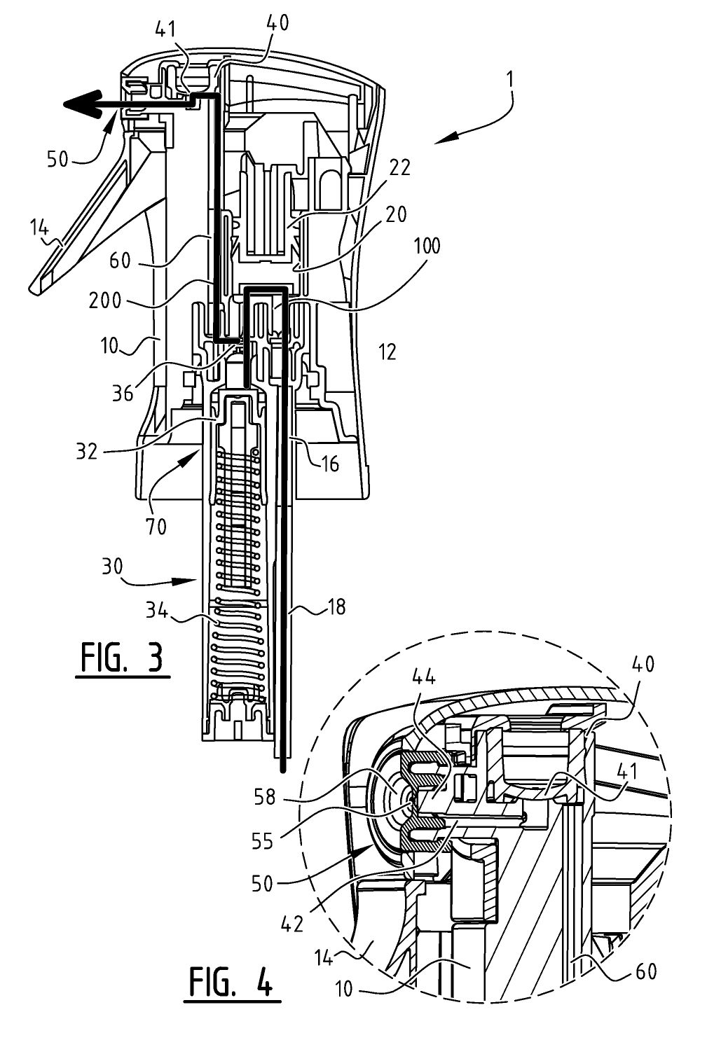

Referring to FIG. 2, a dispensing apparatus 1, from which a direct-foam cleaning composition of the present invention may be dispensed, is shown. The dispensing apparatus 1 includes a spray engine frame 10 that fluidly connects a liquid inlet 16 to a pump chamber 20, a buffer chamber 30, a pre-compression valve 40, and a nozzle 50. The liquid composition 100 travels through the flow path 200 shown in FIG. 3 and is dispensed as a direct-foam product. The liquid inlet 16 may fluidly connect to an optional dip tube 18 to draw liquid composition 100 from a bottle or reservoir (not shown) through the flow path 200 of the sprayer 1. The bottle and liquid composition 100 may be separately sold or provided as a refill for the direct-foam cleaning product. Liquid composition 100 from the reservoir can also be drawn into the sprayer 1 without the dip tube 18 using, for example, known airless systems with a collapsible inner structure, like bag-in-bottle, delaminating bottles like the applicant's Flair® bottle technology or other airless technologies know in the art.

The dispensing apparatus 1 may include an actuation element, such as a trigger 14 as shown in FIG. 2, or another known actuation element (e.g. push button, etc.), which is mechanically connected to a piston 22. In operation, when the spring loaded trigger 14 is actuated by a user, the piston 22 moves down and, when the trigger 14 is released, the force of the spring moves the piston 22 back up. This expands the volume of the chamber and generates an underpressure that opens an inlet valve 12 and closes an outlet valve 36 and causes the liquid composition 100 to be sucked up into the pump chamber 20. As the inlet valve 12 opens, the outlet valve 36 closes (the underpressure moves the outlet valve upwards into a closed position).

When the trigger 14 is actuated or pulled in by a user, it creates a down stroke in the pump chamber 20. The piston 22 moves down and pushes liquid into an outlet channel 60 leading towards the pre-compression valve 40. The buffer chamber 30 is also connected to this outlet channel 60. The inlet valve 12 closes and the outlet valve 36 opens, thus letting the liquid composition 100 pass to the outlet channel 60 and to the pre-compression valve 40. When the pressure generated by the down stroke of the pump piston 22 exceeds a cracking pressure of the pre-compression valve 40, a diaphragm 41 of the valve is elastically deformed and the valve is moved into its open position. The liquid then flows towards the nozzle 50, where it is dispensed as foam.

When the trigger 14 is actuated, the inlet valve 12 closes, preventing the liquid from the pump chamber 20 being pushed back into the bottle/reservoir (pressure moves it downwards into closed position). This allows a pressure to be built up in the outlet channel 60 and buffer chamber 30. Since the displacement volume of the pump is greater than the maximum throughput of the nozzle 50, the pressure in the outlet channel 60 rises during the down stroke of the pump piston 22.

This pressure acts on the resiliently compressible variator 70 that is arranged in the buffer chamber 30 for varying the usable volume of the buffer chamber. In this embodiment the variator 70 includes a buffer piston 32 and a buffer spring 34 engaging the piston.

The pressure of the liquid composition 100 in the buffer chamber 30 pushes down on the buffer piston 32, and the buffer spring 34 underneath the buffer piston 32 is thereby compressed, thus increasing the usable volume of the buffer chamber 30 and allowing liquid composition temporarily to be stored under pressure (pressurized) in the buffer chamber 30.

There is an overflow opening (not shown) at a certain depth of the buffer chamber 30. This is done to prevent too much build up of liquid pressure and, thus, is a kind of outlet at a certain defined point beyond which the buffer piston 32 cannot travel downward. Thus, when the buffer piston 32 moves beyond a certain point (at maximum desired pressure/spring force), liquid will flow back into the reservoir through the overflow opening in the wall of the buffer chamber 30. The liquid overflow opening can be set for a maximum buffer spring 34 pressure in the buffer chamber 30 of, for example, 0.5 to 3.0, or 0.5 to 1.0 bar, above the preset opening pressure or cracking pressure of the pre-compression valve 40. In exemplary embodiments of the present invention, such pre-compression valve opening pressure can be, for example, 1.5, 2.5, 3.5 or even 6 bar or more. In a preferred embodiment of the invention, the opening pressure is between 2 and 4.5 bar, more in particular about 3 to 3.5 bar.

It is noted that in exemplary embodiments of the present invention, the pre-compression valve 40 has a lower opening pressure than the maximum pressure that can develop in the buffer chamber 30. In this way, the pre-compression valve 40 will open and spray can occur well before the buffer chamber 30 is fully filled with liquid and thus reaching its maximum pressure. This allows for continuous spray conditions. More particularly, when more liquid is available in the sprayer than the nozzle 50 can spray (the nozzle is restricted by the maximum flow rate through the nozzle), the remaining liquid is stored in the buffer chamber 30 and is gradually released over a certain time until the pressure drops below the pre-compression valve closing pressure which will shut off the liquid flow. This allows for long duration spraying with a single actuation and continuous spraying with multiple actuations at certain actuation intervals. For instance, if the nozzle 50 can only spray 1 ml/s and 1.4 ml of liquid is pumped in one actuation, the spray will continue for 1.4 seconds. If three actuations of 1.4 ml of liquid will be pumped in 2 seconds, the sprayer will continue spraying for 4.2 seconds.

The pre-compression valve 40 controls the spray action from the nozzle 50. The pre-compression valve 40 has a defined pressure; when the pressure of the liquid exceeds such defined pressure, the pre-compression valve opens and a spray results. When the pressure falls below the defined closing pressure of pre-compression valve 40, the pre-compression valve closes, thereby insuring that only properly pressurized liquids can proceed to the nozzle 50 an insure a continuous spray. The pre-compression valve 40 opens because of the liquid pressure in the outlet channel 60 and buffer chamber 30, and the liquid composition 100 thus passes towards the nozzle 50 creating a desired spray.

As stated above, when the trigger 14 is actuated, the inlet valve 12 closes, preventing the liquid from the pump chamber 20 being pushed back into the bottle/reservoir. Although the dispensing apparatus 1 may be in a subsequent trigger release and liquid intake step, liquid composition 100 can still pass by the pre-compression valve 40 and through the orifice 50 to continue the spray. It is in this manner that a user can cause a continuous spray—as long as the user continues to pump the trigger 14 such that the liquid intake strokes keeps up with the spray, liquid composition 100 continues to be drawn up and sent to the pressure chamber and the pre-compression valve. In this context, it is noted that by varying the relative volumes of the pump chamber 20 and the buffer chamber 30, various speeds of pumping can be designed.

Referring now to FIG. 4, a nozzle 50 is shown having a liquid spinner shaft 44 positioned in the liquid discharge passage 42. The spinner shaft 44 leads to a swirl chamber 52 at one end adjacent the nozzle orifice 55. The spinner shaft 44 extends axially in the downstream direction to the orifice 55. The orifice 55 leads to a conical expansion area 58 which guides the spray angle of the liquid exiting the orifice 55.

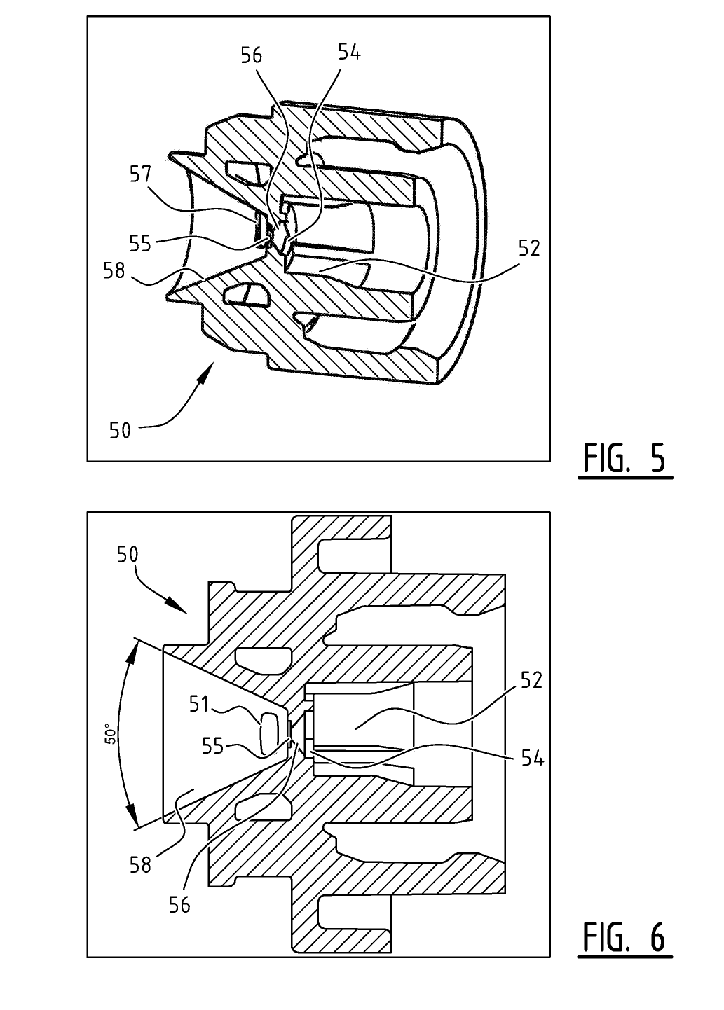

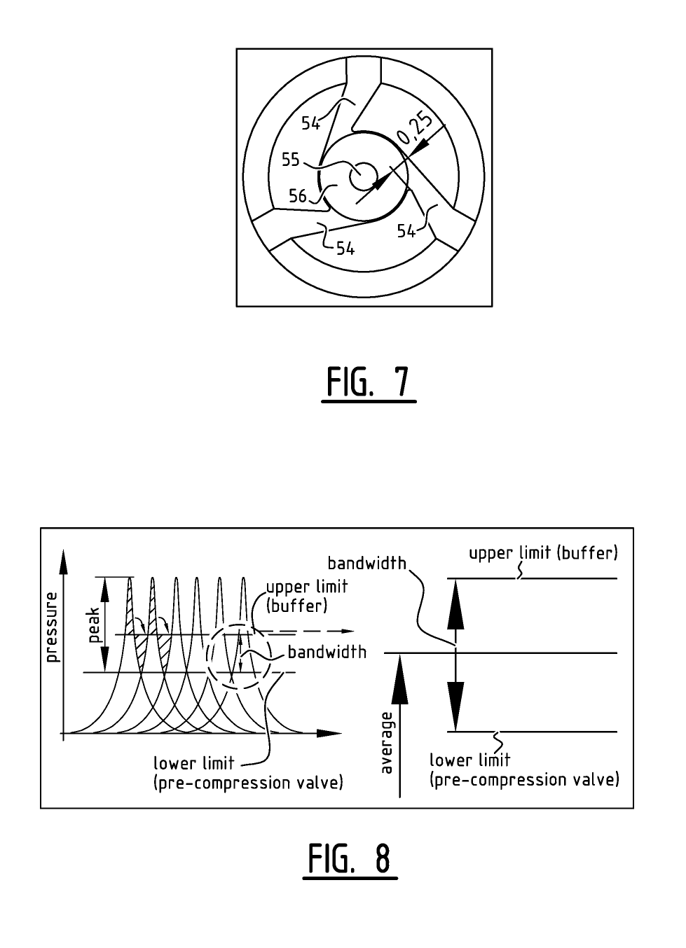

Referring to FIG. 5, the nozzle 50 includes a plurality of swirl grooves 54 and an orifice 55 which provides an exit path through the nozzle 50. The swirl grooves 54 may be one to five, three to five, or three in count. On the inside of the nozzle 50, the swirl grooves 54 guide the liquid into an inner funnel or cone 56 which ends at its narrow end into a short cylindrical orifice 55.

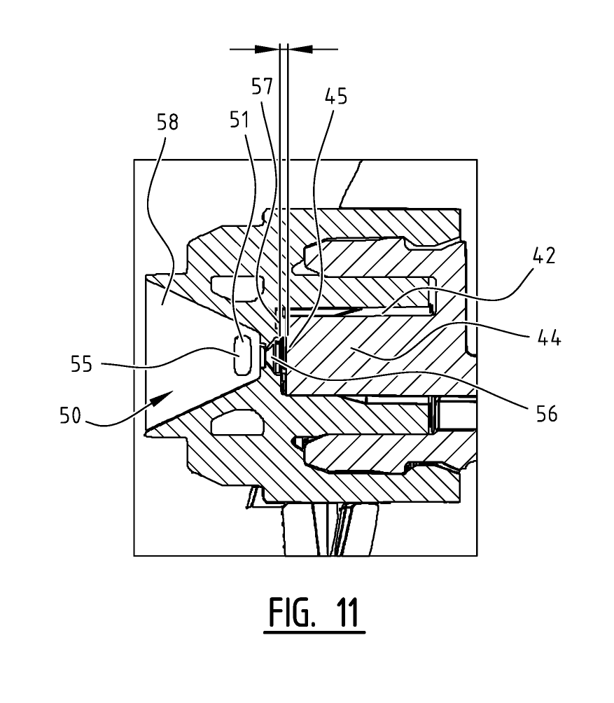

As shown in FIG. 11, the spinner shaft 44 does not extend all the way to the swirl chamber 52. In fact, an end face 45 of the spinner shaft 44 is spaced apart from a bottom 57 of a central bore 59 of the nozzle 50. In this way part of the liquid is not forced to flow through the swirl grooves 54, but may bypass these swirl grooves and flow through the center of the inner funnel or cone 56 of the nozzle. The liquid flow is thus made up of two subflows, a flow through the swirl grooves 54 and a flow through the center, which have different velocities. Without wishing to be bound by theory, it is assumed that the higher velocity flow will entrain the lower velocity flow, so that the entire body of liquid flowing towards the nozzle orifice is energized. The end result of this arrangement is observed to be an improvement of the foaming characteristics.

The swirl grooves 54 can vary in shape, width and depth and can taper from wide to narrow to accommodate the best acceleration of the flow of the liquid with the least resistance and pressure drop. The inner cone 56 may have an angle of about 20° to about 150°, preferably about 50° to about 120°, and more preferably about 100°. The inner cone 56 defines how much the spinning liquid is further accelerated before the orifice 55 and, as such, the spread or how wide the spray comes out of the orifice 55. The swirl grooves 54 accelerate and swirl the liquid under pressure into the inner cone 56 where the gradual reduction in diameter compresses and accelerates the liquid further to spray it out under high pressure through the narrow orifice 55. The sudden pressure drop at the exit of the orifice 55 allows the compressed highly energized liquid to expand and breaks up the liquid into small droplets. The velocity, direction, and spray width of the sprayed droplets is defined by the energy and the trajectory introduced by the swirl grooves 54 and the angle on the inner cone 56. The short cylindrical path in the orifice 55 should be kept as short as technically possible to not impact the width of the spray.

On the outside of the orifice 55 or downstream of the orifice, an expansion area in the shape of an external cone 58 is provided which guides the spray angle of liquid droplets exiting the orifice. This external cone 58 may have an angle of about 20° to about 120°, preferably about 30° to about 90°, and more in particular about 50°. The external cone 58 is further provided with a number of aerating openings 51. The sudden pressure drop at the exit generates an underpressure in the center of the spray. This underpressure will suck in air from the environment into the spray. As a result the small droplets being formed at the exit turn into small foam bubbles. This effect is further enhanced by the external cone 58 which also guides the liquid stream outwards to further break up the spray into a wide foam spray pattern. The foam particles can be further tuned by introducing more air through the aerating holes 51 in the external cone 58 positioned close to the zone with the highest underpressure. Via the venturi effect this underpressure will suck in more air into the stream of droplets generating thicker, more pronounced foam.

The orifice 55 may be of constant diameter or may taper in the axial direction, widening in diameter as the spray travels from a proximal end (i.e. closest to the orifice 55 and the flow path 200) to a distal end of the nozzle 50. A constant orifice diameter may be about 0.10 mm to about 0.60 mm, or about 0.30 mm to about 0.40 mm, or about 0.32 mm to about 0.37 mm, or about 0.36 mm. When tapered, the orifice 55 may taper from a proximal end diameter of about 0.13 mm to a distal end diameter of about 1 mm to about 5 mm to a distal end diameter of about 0.10 mm to about 0.60 mm, or about 0.30 mm to about 0.40 mm.

Exemplary nozzle configurations are provided in Table 1.

TABLE 1

| Dual | |
|---|---|
| Nozzles | Parameters |
| Nozzle 1 | Orifice diameter: 0.35 mm |
| | Inner cone angle: 100° |
| | Three swirl grooves; depth of grooves is 0.22 smallest pass |
| | Trough of grooves: 0.25 mm |
| | External cone angle: 50° with aerating holes (to allow |
| | more air to be pulled into the cone) |
| | Buffer pressure: 5.0 to 5.2 bar |
| | Pre-compression valve pressure: 3.0 to 3.5 bar |
| Nozzle 2 | Orifice diameter: 0.30 mm |
| | Inner cone angle: 100° |
| | Three swirl grooves; depth of grooves is 0.50 mm smallest |
| | pass |
| | Trough of grooves: 0.25 mm |
| | External cone angle: 50° with aerating holes |
| | Buffer pressure: 5.0 to 5.2 bar |
| | Pre-compression valve pressure: 3.0 to 3.5 bar |

As stated above, the arrangement of the pump, the buffer and the nozzle is such, that the liquid will be dispensed at a pressure that lies within a relatively narrow bandwidth. The lower limit of the dispensing pressure is determined by the cracking pressure of the pre-compression valve 40. As soon as the pump 20 generates a pressure that is higher than the cracking pressure, the pre-compression valve 40 will open, allowing liquid to flow from the pump 20 through the outlet channel 60 to the nozzle 50. As the nozzle 50 is designed to have a maximum throughput that is less than the displacement capacity of the pump 20, the pressure of the liquid in the outlet channel 60 will rise as the liquid cannot exit the nozzle 50 at the same rate that it is forced into the outlet channel 60 by the pump 20. This pressure rise will continue until the pressure of the liquid in the outlet channel 60 equals the pressure of the resiliently compressible variator 70. As soon as this pressure is reached, the variator 70 will start to be compressed, thus increasing the usable volume in the buffer chamber 30 that is available to accommodate the liquid that cannot exit through the nozzle 50. In this way the pressure at which the liquid is dispensed from the nozzle 50 is maximized at the value of the pressure of the variator 70 in the buffer chamber 30. As stated above, the buffer chamber may include an overflow opening to allow the liquid to return to the container if the pressure generated by the pump in the outlet channel and buffer chamber becomes excessive. The narrow bandwidth of the dispensing pressure is illustrated in FIG. 8, where each curve represents the pressure build-up as a result of a pump stroke, and the lower and upper limit lines 80, 90 represent the cracking pressure of the pre-compression valve 40 and the pressure of the variator 70 in the buffer chamber 30, respectively.

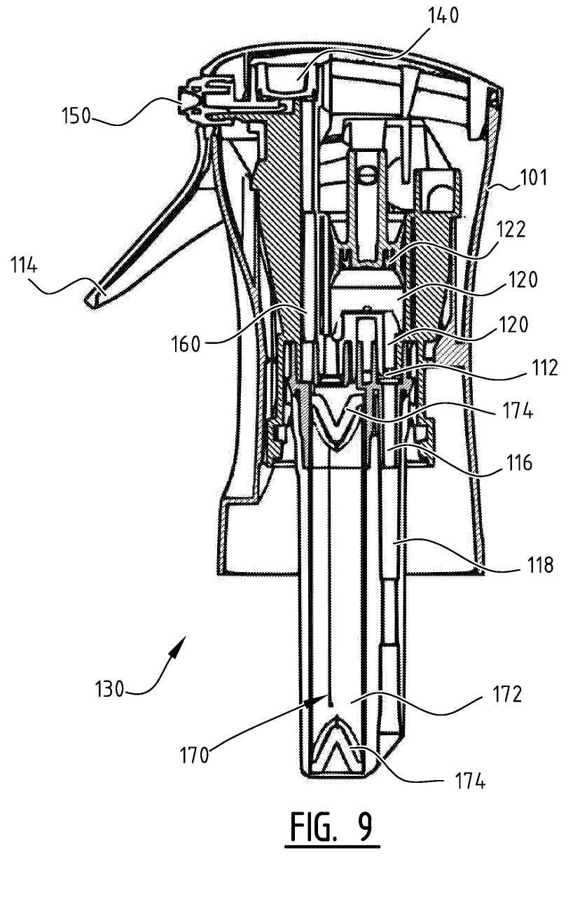

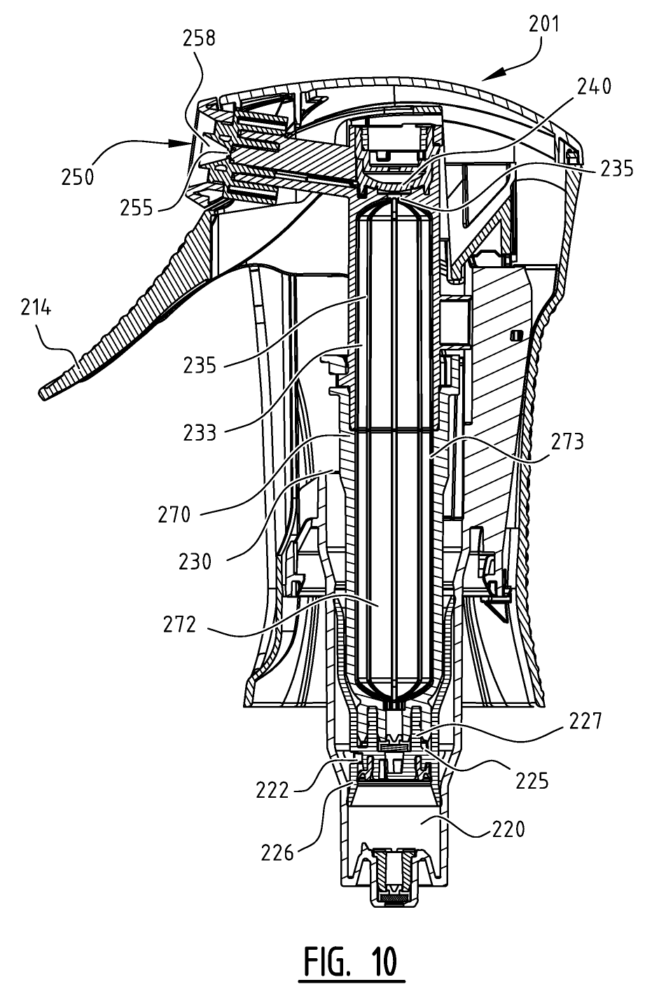

In an alternative embodiment of the dispensing system (FIG. 9), the resiliently compressible variator 170 includes a bag 172 filled with a pressurized medium, in particular a pressurized gas. This bag 172 is arranged in the buffer chamber 130 and substantially takes up the entire interior volume of the buffer chamber, so that no liquid can remain in the buffer chamber 130. In this embodiment the bag 172 consists of a plastic tube filled with gas at the predetermined maximum dispensing pressure and sealed at its opposite ends by weld lines 174. This gas filled bag variator 170 functions substantially in the same way as the spring loaded piston variator 32 of the previous embodiment. When the liquid pressure in the outlet channel 160 exceeds the pressure of the gas in the tubular bag 172, the bag will start to be compressed, thus freeing up space in the buffer chamber 130 for the liquid to enter. When the pump piston 122 reaches the end of its stroke and the pressure build-up stops, the liquid will continue to flow from the buffer chamber 130 through the outlet channel 160 towards the nozzle 150, as the pressure in the system still exceeds the cracking pressure of the pre-compression valve 140. As the liquid continues to be dispensed, the pressure in the outlet channel 160 and buffer chamber 130 will decrease and the resilient variator 170 will expand. In this way the liquid will be forced from the buffer chamber 130 until the buffer chamber is empty. The flow of liquid out through the nozzle 150 will stop as soon as the pressure drops below the cracking pressure of the pre-compression valve 140.

In yet another embodiment of the dispensing system (FIG. 10) the buffer chamber 230 is effectively formed by a widened part of the outlet channel 206, which in turn is partially accommodated in the piston 222 of the pump 220. Here the resiliently compressible variator 270 is again embodied as a plastic bag 272 filled with gas under pressure, which takes up substantially the entire internal volume of the buffer chamber 230. Liquid can flow past the gas filled bag 272 through spaces 273 left free between the periphery of the gas filled bag 272 and the inner 233 wall of the buffer chamber 230. In this embodiment the inner wall 233, when viewed in cross-section, has a serrated configuration, defining ridges or ribs engaging the gas filled bag 272, which are separated by recesses serving as flow passages 273 for the liquid. Together these flow passages 273 form the nominal outlet channel 260. These liquid flow passages 273 come together in an opening 235 at the top of the buffer chamber 230, which is closed off by the pre-compression valve 240.

In this embodiment the piston 222, which is arranged on the lower end of the buffer chamber 230, is held stationary and the pump chamber 220 is upwardly movable with respect to the fixed piston 222 when the trigger 214 is actuated. When the pump chamber 220 is moved upwards relative to the piston 222, the liquid in the pump chamber 220 is compressed and is forced out of the pump chamber 220 through a central opening 225 arranged in the bottom 226 of the piston 222. This central opening 225, which during an inlet stroke is closed by a valve 227, is in fluid communication with the liquid flow passages 273 arranged in the wall 233 of the buffer chamber 230.

As soon as the pump generates a pressure which is higher than the cracking pressure of the pre-compression valve 240, this pre-compression valve opens and the liquid can flow towards the nozzle 250 to be dispensed as foam. Here again, as the pressure builds up and reaches the gas pressure in the bag 272, the variator 270 will start to be compressed and will create additional space in the buffer chamber 230 for the liquid to occupy. And when the pump chamber 220 reaches the end of its stroke and pressure build-up stops, liquid will continue to flow towards the nozzle 250, thus allowing the gas filled variator bag 272 to expand again and the buffer chamber 230 to be emptied. When the buffer chamber 230 has been completely emptied, the liquid pressure will have dropped below the cracking pressure of the precompression valve 240, and no more foam is dispensed.

### Cleaning Composition

The direct-foam cleaning product to be dispensed with the dispensing system of the present invention comprises a cleaning composition comprising a surfactant system and, optionally, an organic grease cleaning solvent. The suds generated when spraying this cleaning composition are strong enough to withstand the impact force when the direct-foam cleaning product contacts the article to be washed (i e minimizes bounce back, inhalation, and product waste), but at the same time are easy to rinse. This direct-foam cleaning product provides good cleaning, including cleaning of tough food soils such as cooked-, baked- and burnt-on soils and good cleaning of light oily soils. The direct-foam cleaning product to be dispensed with the dispensing system of the invention also provides good detergent spreading, requiring reduced scrubbing by the consumer.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” Further, it should be understood that every maximum numerical limitation given throughout this specification will include every lower numerical limitation, as if such lower numerical limitations were expressly written herein. Likewise, every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. Features disclosed in connection with a particular embodiment may be used in other embodiments or combined with features from such other embodiments to form new embodiments. For instance, although the nozzle designs disclosed here are suited for use in combination with a dispensing apparatus having a buffer and a pre-compression valve, they may also be used in combination with conventional trigger sprayers. It is therefore intended to cover in the appended claims all such changes and modifications that are within the scope of this invention.

1-28. (canceled)

29. A system for dispensing a liquid foam, in particular a direct foam cleaning product, comprising a container for the liquid and a dispensing apparatus connected to the container, wherein the dispensing apparatus comprises:
a pump comprising a pump chamber in fluid communication with the container and a piston arranged in the pump chamber, the piston and pump chamber being movable with respect to one another;
an outlet channel connecting the pump chamber to a nozzle,
a pre-compression valve arranged between the outlet channel and the nozzle, and
a buffer comprising a buffer chamber connected to the outlet channel, the buffer chamber including a compressible variator arranged therein for varying the usable volume of the buffer chamber,
wherein the nozzle, the buffer and the pump are configured and dimensioned such that the foam is dispensed in a predetermined spray pattern.

30. The dispensing system as claimed in claim 29, wherein the pre-compression valve and the buffer chamber are arranged to define lower and upper limits, respectively, of a dispensing pressure of the foam.

31. The dispensing system as claimed in claim 30, wherein at least one of:
the pre-compression valve has a cracking pressure of about 2 to 4.5 bar, and
the buffer chamber and the variator define a maximum value of the dispensing pressure of between 3 and 5.5 bar.

32. The dispensing system as claimed in claim 30, wherein the pump has a displacement volume that is greater than a maximum throughput of the nozzle, optionally wherein the maximum throughput of the nozzle is about 1.45 cm³ per second.

33. The dispensing system as claimed in claim 29, wherein the buffer chamber has a maximum usable volume that is greater than the displacement volume of the pump.

34. The dispensing system as claimed in claim 29, wherein the nozzle has a plurality of swirl grooves leading to an inlet funnel, which funnel debouches in a nozzle orifice.

35. The dispensing system as claimed in claim 34, wherein at least one of:
the nozzle has a central bore upstream of the inlet funnel, which is arranged to accommodate a protruding part of the dispenser frame, and wherein the central bore is dimensioned such that a space is formed between and end face of the protruding frame part and a bottom of the bore;
the inlet funnel is conical and has a top angle of about 20-150; and
the nozzle has an odd number of swirl grooves.

36. The dispensing system as claimed in claim 29, wherein the nozzle has a divergent expansion area downstream of the nozzle orifice.

37. The dispensing system as claimed in claim 36, wherein at least one of:
the expansion area has aeration openings; and
the expansion area is conical and has a top angle of between about 20-120°.

38. The dispensing system as claimed in claim 29, wherein the variator comprises:
a piston that is movable in the buffer chamber and a compression spring engaging the variator piston; or
a bag filled with a compressible medium; optionally wherein the buffer chamber is integrated in the outlet channel.

39. The dispensing system as claimed in claim 29, wherein the container is a bag-in-bottle type container.

40. The dispensing system as claimed in claim 29, further comprising a movable trigger connected to the pump piston or pump chamber.

41. A method for dispensing a liquid foam, in particular a direct foam cleaning product, comprising the steps of:
drawing the liquid from a container and pressurizing the liquid by actuating a pump, wherein the container and the pump form part of a dispensing system,
guiding at least a part of the pressurized liquid to a dispensing nozzle of the dispensing system,
dispensing the liquid from the nozzle,
storing another part of the pressurized liquid in a buffer, and
dispensing the stored liquid from the nozzle when the pump is not being actuated,
wherein the nozzle, the buffer and the pump are configured and dimensioned such that the foam is dispensed in a predetermined spray pattern.

42. The method as claimed in claim 41, wherein the liquid is dispensed from the nozzle only when a pressure of the liquid exceeds a cracking pressure of a pre-compression valve arranged upstream of the nozzle.

42. The method as claimed in claim 41, wherein the pressurized liquid is stored in a buffer as long as the pressure of the liquid exceeds a pressure generated by a compressible variator in the buffer.

43. The method as claimed in claim 41, wherein actuating the pump causes a volume of liquid to be drawn from the container and pressurized that is greater than a maximum throughput of the nozzle, thus causing an excess volume of the liquid to be stored in the buffer.

44. The method as claimed in claim 41, wherein upon reaching the nozzle at least part of the pressurized liquid is brought into rotation by swirl grooves and accelerated in a conical funnel towards the nozzle orifice.

45. The method as claimed in claim 44, wherein part of the pressurized liquid bypasses the swirl grooves.

46. The method as claimed in claim 44, wherein after passing through the nozzle orifice, the liquid is expanded in a divergent nozzle portion to form a foam; optionally wherein during expansion and foaming the liquid is mixed with ambient air drawn into the expanding liquid flow.

47. A nozzle, in particular for use in a dispensing system as claimed in claim 29.
